(19) United States
(12) Patent Application Publication
(10) Pub. No.: US 2026/0199829 A1
(43) Pub. Date: Jul. 16, 2026

(54) METHODS OF CONTROL FOR CO2 CAPTURE SYSTEMS USING MOLTEN SALTS

(71) Applicant: Mantel Capture, Inc., Cambridge, MA (US)

(72) Inventors: Cameron Halliday, Boston, MA (US); Sean Robertson, Cambridge, MA (US)

(21) Appl. No.: 19/355,257

(22) Filed: Oct. 10, 2025

Related U.S. Application Data
(63) Continuation of application No. PCT/US2024/024157, filed on Apr. 11, 2024.
(60) Provisional application No. 63/495,760, filed on Apr. 12, 2023.

(51) Int. Cl. B01D 53/62; B01D 53/14; B01D 53/78; B01D 53/96

(52) U.S. Cl. CPC B01D 53/62; B01D 53/1425; B01D 53/1475; B01D 53/78; B01D 53/96; B01D 2251/602; B01D 2257/504

(57) ABSTRACT

The present disclosure provides systems and methods for capturing carbon dioxide and storing thermochemical energy using molten salts. Streams comprising carbon dioxide from an industrial process may be contacted with a molten borate salt to produce carbon rich molten salt streams. The carbon rich molten salt streams may be directed to a desorber where the molten salt is regenerated without the use of external energy and pure carbon dioxide is released and used elsewhere. Thermochemical energy storage can be integrated into a carbon capture system by manipulating the volume of stored molten salt within a storage environment. The temperature of the storage environment may be manipulated by altering the partial pressure of carbon dioxide in the storage environment which may prevent the freezing of molten salt.

### CROSS-REFERENCE

This application is a continuation application of International Patent Application No. PCT/US2024/024157, filed Apr. 11, 2024, which claims the benefit of U.S. Provisional Application No. 63/495,760, filed Apr. 12, 2023, each of which is incorporated herein by reference in its entirety.

### BACKGROUND

Industrial processes may generate carbon-containing products, such as carbon dioxide (CO₂). CO₂ is a greenhouse gas that may affect a change in the temperature of the Earth and contribute to global warming. Such industrial processes may include coal, oil, or fossil-fuel fired power plants, manufacturing processes, oil refineries, or any other process that produces carbon-containing products, either intentionally or as an unwanted by-product. Traditionally, CO₂ has been released into the environment or processed using an inefficient and resource intensive scrubber.

### SUMMARY

The present disclosure provides carbon capture systems and methods that may be efficient and economical at abating CO₂ emissions from fossil fuel industries. Such carbon capture systems can be used for thermochemical energy storage at a CO₂ producing system.

The present disclosure provides molten salt materials that are capable of capturing CO₂ emissions form industrial processes. The carbon capture reaction between molten borate materials and CO₂ can be used to store thermochemical energy. In some cases, a thermochemical energy storage system can be integrated into the carbon capture system. After capturing carbon using molten borate materials, the volume of stored molten salt within a storage environment can be manipulated to meet energy demands. In this way the combined system can store energy for load-following purposes while continuing to capture CO₂ at a constant rate from the CO₂ producing system.

In one aspect, described herein is a method comprising: (a) directing a first stream comprising carbon dioxide (CO2) into an absorber comprising a molten salt; (b) in the absorber, contacting the first stream comprising CO2 with the molten salt such that at least a portion of CO2 from the first stream is absorbed into the molten salt to provide a molten salt stream comprising absorbed CO2, wherein absorption of CO2 into the molten salt yields energy; (c) directing the molten salt stream from the absorber to a storage tank comprising a headspace; and (d) directing a second stream comprising CO2 to the headspace of the storage tank.

In some embodiments described herein, the method further comprises determining a demand for the energy. In some embodiments, in (d), at least a portion of CO₂ in the second stream is absorbed into the molten salt stream in the storage tank, thereby resulting in an increased amount of CO₂ in the molten salt stream, and thereby obtaining a first additional molten salt stream.

In some embodiments described herein, the method further comprises directing the first additional molten salt stream comprising CO₂ from the storage tank to a desorber when the demand is below a threshold value. In some embodiments, the absorption of CO₂ from the second stream into the molten salt stream releases heat into the storage tank. In some embodiments, the heat maintains the molten salt stream in the storage tank at a temperature or temperature range above a freezing point of the molten salt stream. In some embodiments, in the desorber, CO₂ desorbs from the first additional molten salt stream, resulting in a third stream comprising CO₂ and a second additional molten salt stream. In some embodiments, the first additional molten salt stream comprises a first concentration of CO₂ and the second additional molten salt stream comprises a second concentration of CO₂, wherein the first concentration is different than the second concentration. In some embodiments, the first concentration of CO₂ is greater than the second concentration of CO₂.

In some embodiments described herein, the method further comprises directing the second additional molten salt stream to an additional storage tank comprising an additional headspace. In some embodiments described herein, the method further comprises directing a fourth stream comprising CO2 to the additional headspace of the additional storage tank.

In some embodiments, at least a portion of CO2 in the fourth stream is absorbed into the second additional molten salt stream in the additional storage tank, thereby resulting in an increased amount of CO₂ in the second additional molten salt stream, and thereby obtaining a third additional molten salt stream. In some embodiments, the absorption of CO₂ from the fourth stream into the second additional molten salt stream releases heat into the additional storage tank. In some embodiments, the heat maintains the second additional molten salt stream in the additional storage tank at a temperature or temperature range above a freezing point of the second additional molten salt stream.

In some embodiments described herein, the method further comprises directing the third additional molten salt stream to the absorber when the demand is above a threshold value. In some embodiments, in the absorber, the third additional molten salt stream contacts the first stream comprising CO₂. In some embodiments, at least a portion of the third stream comprising CO₂ is directed to the headspace of the storage tank. In some embodiments, less than 10% of the third stream comprising CO₂ is directed to the headspace of the storage tank. In some embodiments, less than 5% of the third stream comprising CO₂ is directed to the headspace of the storage tank. In some embodiments, less than 1% of the third stream comprising CO₂ is directed to the headspace of the storage tank. In some embodiments, the second stream comprises at least a portion of the third stream. In some embodiments, the fourth stream comprises at least a portion of the third stream.

In some embodiments described herein, the method further comprises directing at least a portion of the first stream comprising CO₂ to the headspace of the storage tank such that the headspace and the molten salt stream are about in chemical equilibrium. In some embodiments, a level of the molten salt stream in the storage tank is controlled in an absence of pressurizing or in an absence of depressurizing the storage tank.

In some embodiments described herein, the method further comprises directing at least a portion of the first stream comprising CO2 to the headspace of the additional storage tank such that the headspace and the second additional molten salt stream are about in chemical equilibrium. In some embodiments, a level of the second additional molten salt stream in the additional storage tank is controlled in an absence of pressurizing or in an absence of depressurizing the additional storage tank. In some embodiments, the first stream comprising CO₂ is output from an industrial process. In some embodiments, the industrial process comprises burning a solid fuel. In some embodiments, the solid fuel comprises coal, biomass, waste, or refuse, or any combination thereof. In some embodiments, the industrial process comprises burning a gaseous fuel.

In some embodiments, the gaseous fuel comprises natural gas, methane, propane, or refinery gas, or any combination thereof. In some embodiments, the industrial process comprises burning a liquid fuel. In some embodiments, the liquid fuel comprises oil, oil-products, petrol, diesel, kerosene, bio-diesel, or any combination thereof. In some embodiments, the industrial process comprises a coal fired power plant, a natural gas fired power plant, an industrial heating facility, a cement plant, a steel mill, a hydrogen production facility, a pulp and paper mill, a waste-to-energy power plant, or a bioenergy power plant. In some embodiments, the headspace comprises CO₂, an inert gas, a flue gas, or a combination thereof. In some embodiments, the inert gas comprises nitrogen or air, or a combination thereof.

In some embodiments, the molten salt has a formula of AₓB₁₋ₓO_{1.5-x}, wherein ‘A’ is an ion with a positive charge, ‘B’ is boron, ‘O’ is oxygen, and ‘x’ is a number greater than or equal to 0.5 and less than 1.0. In some embodiments, ‘A’ an alkali metal, alkaline metal, transition metal, or a combination thereof. In some embodiments, ‘A’ is lithium, potassium, sodium, or a combination thereof.

In some embodiments, a concentration of CO₂ in the storage tank is at least about 0.1 mol per kilogram of the molten salt. In some embodiments, a concentration of CO₂ in the storage tank is at least about 0.5 mol per kilogram of the molten salt. In some embodiments, a concentration of CO₂ in the storage tank is at least about 1.0 mol per kilogram of the molten salt. In some embodiments, the second stream comprising CO₂ is at a controlled temperature. In some embodiments, the second stream comprising CO₂ is at a temperature of at least about 100° C. In some embodiments, the second stream comprising CO₂ is at a temperature of at least about 200° C. In some embodiments, the second stream comprising CO₂ is at a temperature of at least about 300° C. In some embodiments, the second stream comprising CO₂ is at a temperature of at least about 600° C. In some embodiments, the molten salt stream is directed using one or more pumps. In some embodiments, the one or more pumps operate at a temperature of at least about 400° C. In some embodiments, the one or more pumps operate at a temperature of at least about 600° C.

In some embodiments, a concentration of CO₂ in the headspace is less than a concentration of the CO₂ in the first stream. In some embodiments, the concentration of CO₂ in the headspace is less than 50% of the concentration of CO₂ in the first stream. In some embodiments, the concentration of CO₂ in the headspace is less than 20% of the concentration of CO₂ in the first stream. In some embodiments, the concentration of CO₂ in the headspace is less than 10% of the concentration of CO₂ in the first stream.

Additional aspects and advantages of the present disclosure will become readily apparent to those skilled in this art from the following detailed description, wherein only illustrative embodiments of the present disclosure are shown and described. As will be realized, the present disclosure is capable of other and different embodiments, and its several details are capable of modifications in various obvious respects, all without departing from the disclosure. Accordingly, the drawings and description are to be regarded as illustrative in nature, and not as restrictive.

### INCORPORATION BY REFERENCE

All publications, patents, and patent applications mentioned in this specification are herein incorporated by reference to the same extent as if each individual publication, patent, or patent application was specifically and individually indicated to be incorporated by reference. To the extent publications and patents or patent applications incorporated by reference contradict the disclosure contained in the specification, the specification is intended to supersede and/or take precedence over any such contradictory material.

### BRIEF DESCRIPTION OF THE DRAWINGS

The novel features of the systems and methods described herein are set forth with particularity in the appended claims. A better understanding of the features and advantages of the systems and methods described herein will be obtained by reference to the following detailed description that sets forth illustrative embodiments and the accompanying drawings (also “Figure” and “FIG.” herein) of which:

FIG. 1A schematically illustrates a method for capturing carbon dioxide (CO₂) using molten salts in an absorber, directing the CO₂-rich molten salt to a storage tank comprising a headspace, and further directing CO₂ into the headspace.

FIG. 1B schematically illustrates a method for maintaining the temperature of the storage tank above the molten salt stream freezing point by capturing CO₂ using molten salts in an absorber, directing the CO₂-rich molten salt to a storage tank comprising a headspace, directing CO₂ into the headspace, further absorbing CO₂ into the CO₂-rich molten salt, releasing heat into the storage tank, and using the released heat to maintain the store tank temperature above the molten salt stream freezing point.

FIG. 2 illustrates a process flow diagram of an embodiment of an integrated carbon capture and thermochemical energy storage system. In this configuration, CO₂-containing gas from an industrial process (205) and the desorber (245, 280) can be used as the CO₂ source for the CO₂ rich salt storage tank (290, 230) and CO₂ lean salt storage tank (295, 265), respectively.

FIG. 3 illustrates a simplified process flow diagram showing system configuration of an embodiment of an integrated carbon capture and thermochemical energy storage system. In this configuration, CO₂ sources external to the integrated carbon capture and thermochemical energy storage system (370, 375) can be used as the CO₂ source for the CO₂ rich salt storage tank (290, 230) and CO₂ lean salt storage tank (295, 265), respectively.

FIG. 4 shows a computer system that is programmed or otherwise configured to implement a method for capturing carbon dioxide (CO₂) using molten salts.

### DETAILED DESCRIPTION

While various embodiments of the systems and methods described herein have been shown and described herein, it will be obvious to those skilled in the art that such embodiments are provided by way of example only. Numerous variations, changes, and substitutions may occur to those skilled in the art without departing from the systems and methods described herein. It should be understood that various alternatives to the embodiments described herein may be employed. Unless the context requires otherwise, throughout the specification and claims which follow, the word “comprise” and variations thereof, such as, “comprises” and “comprising” are to be construed in an open, inclusive sense, that is, as “including, but not limited to.”

Whenever the term “at least,” “greater than” or “greater than or equal to” precedes the first numerical value in a series of two or more numerical values, the term “at least,” “greater than” or “greater than or equal to” applies to each of the numerical values in that series of numerical values. For example, greater than or equal to 1, 2, or 3 is equivalent to greater than or equal to 1, greater than or equal to 2, or greater than or equal to 3.

Whenever the term “no more than,” “less than,” or “less than or equal to” precedes the first numerical value in a series of two or more numerical values, the term “no more than,” “less than,” or “less than or equal to” applies to each of the numerical values in that series of numerical values. For example, less than or equal to 3, 2, or 1 is equivalent to less than or equal to 3, less than or equal to 2, or less than or equal to 1.

The term “about” as used herein referring to a number or a numerical range means that the number or numerical range referred to is an approximation within experimental variability (or within statistical experimental error). The number or numerical range may vary between 1% and 15% of the stated number or numerical range.

As used in this specification and the appended claims, the singular forms “a,” “an,” and “the” include plural referents unless the content clearly dictates otherwise. It should also be noted that the term “or” is generally employed in its sense including “and/or” unless the content clearly dictates otherwise.

As used herein, the term “high purity” generally refers to a composition with low levels of impurities. In some cases, high purity refers to a mixture with a concentration of a component of about 80% to about 99.99%. In some cases, high purity refers to a mixture with a concentration of a component of about 80% to about 85%, about 80% to about 90%, about 80% to about 95%, about 80% to about 97%, about 80% to about 99%, about 80% to about 99.9%, about 80% to about 99.99%, about 85% to about 90%, about 85% to about 95%, about 85% to about 97%, about 85% to about 99%, about 85% to about 99.9%, about 85% to about 99.99%, about 90% to about 95%, about 90% to about 97%, about 90% to about 99%, about 90% to about 99.9%, about 90% to about 99.99%, about 95% to about 97%, about 95% to about 99%, about 95% to about 99.9%, about 95% to about 99.99%, about 97% to about 99%, about 97% to about 99.9%, about 97% to about 99.99%, about 99% to about 99.9%, about 99% to about 99.99%, or about 99.9% to about 99.99%. In some cases, high purity refers to a mixture with a concentration of a component of about 80%, about 85%, about 90%, about 95%, about 97%, about 99%, about 99.9%, or about 99.99%. In some cases, high purity refers to a mixture with a concentration of a component of at least about 80%, about 85%, about 90%, about 95%, about 97%, about 99%, or about 99.9%, or more.

The term “in proximity to,” as used herein, generally refers to a distance of at most 20 meters between a A and B. For example, if it is stated that the absorber is positioned in proximity to the boiler, it is understood to mean that a boundary of the absorber is at a distance of at most 20 meters from a boundary of the boiler. In some embodiments, the distance may be at most 20 meters (m), 15 m, 10 m, 9 m, 8 m, 7 m, 6 m, 5 m, 4 m, 3 m, 2 m, 1 m, or less.

The term “industrial process,” as used herein, generally refers to a process that extracts, transports, or processes raw materials to manufacture end products using physical, mechanical and/or chemical processes. An industrial process can generate electricity, steam, water, heat, cement, steel, hydrogen, pulp, paper, carbon dioxide, or a combination thereof. In some examples, an industrial process may refer to any process which generates a product of value. In some embodiments, the industrial process may generate carbon dioxide as a by-product (e.g., by-product of combustion). In some embodiments, the industrial process may generate heat (e.g., thermal energy). Examples of industrial processes include coal fired power plants, oil fired power plants, gas fired power plants, or any other fossil-fuel fired power plants. A fossil fuel may comprise coal, petroleum, natural has, oil shales, bitumens, tar sands, and heavy oils.

The term “high temperature system” as used herein generally refers to an entire system or a portion of a system where high temperatures (e.g., exceeding 300° C.) may be reached. An industrial process may comprise one or more high temperature systems. The capture and release of carbon dioxide using molten salts, as described herein, may occur within or in proximity to a high temperature system (e.g., a portion of a system reaching temperatures of at least 300° C.). A high temperature system may comprise a boiler.

The term “carbon capture system” as used herein generally refers to a system comprising at least an absorber and a desorber to capture and release carbon dioxide. A carbon capture system may be a closed-loop system for streams comprising molten salt to move within (e.g., from the absorber to the desorber and back to the absorber). A carbon capture system may be separate from the high temperature system or the system where an industrial process is occurring. A carbon capture system may be integrated directly into a high temperature system (e.g., boiler). A carbon capture system may be positioned near to (e.g., adjacent to) a high temperature system. A carbon capture system may be retroactively fitted (retrofitted) into a pre-existing high temperature system.

### Systems and Methods for CO₂ Capture

Provided herein are systems and methods that may be used to capture carbon dioxide using molten salts.

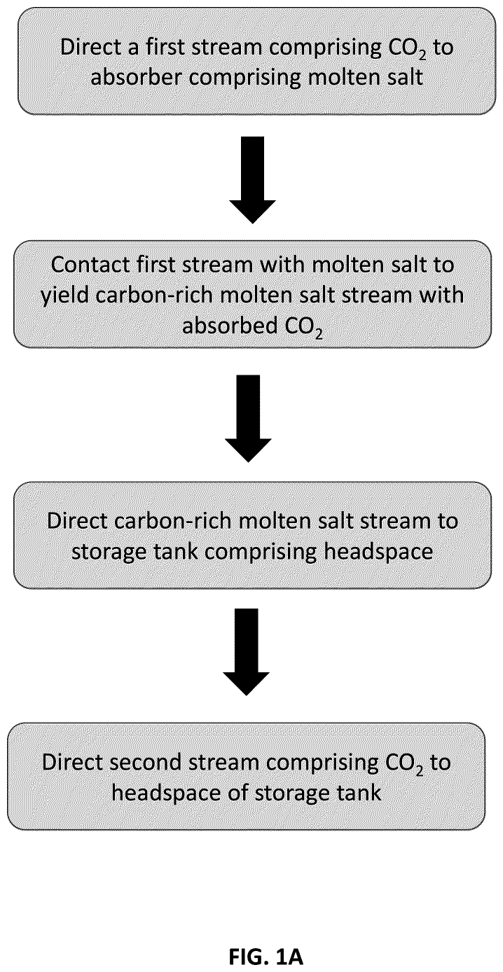

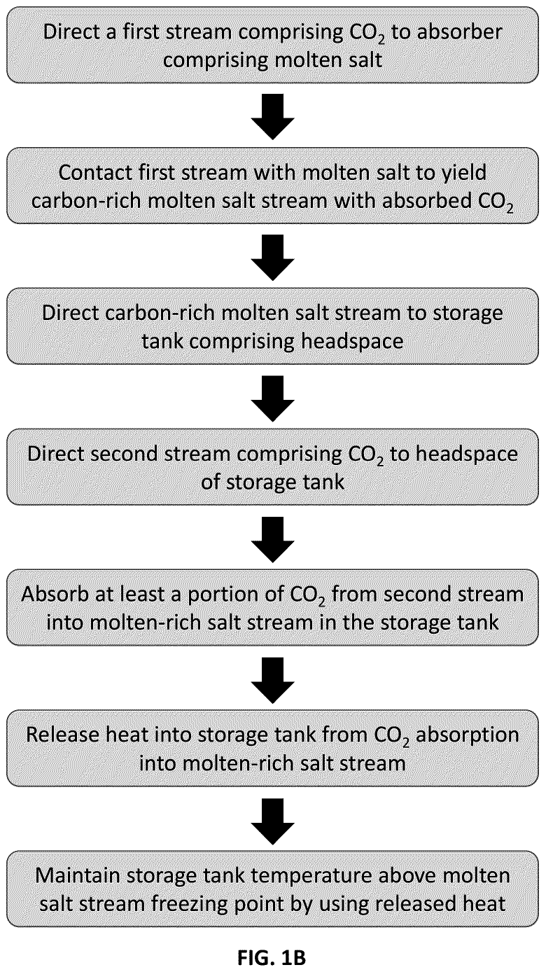

FIG. 1A schematically illustrates a method for capturing carbon dioxide (CO₂) using molten salts in an absorber, directing the CO₂-rich molten salt to a storage tank comprising a headspace, and further directing CO₂ into the headspace. In the example of FIG. 1A, the method comprises (a) directing a first stream comprising carbon dioxide (CO2) into an absorber comprising a molten salt, (b) in the absorber, contacting the first stream comprising CO2 with the molten salt such that at least a portion of CO2 from the first stream is absorbed into the molten salt to provide a molten salt stream comprising absorbed CO2, wherein absorption of CO2 into the molten salt yields energy, (c) directing the molten salt stream from the absorber to a storage tank comprising a headspace, and (d) directing a second stream comprising CO2 to the headspace of the storage tank.

FIG. 1B schematically illustrates a method for maintaining the temperature of the storage tank above the molten salt stream freezing point by capturing CO₂ using molten salts in an absorber, directing the CO₂-rich molten salt to a storage tank comprising a headspace, directing CO₂ into the headspace, further absorbing CO₂ into the CO₂-rich molten salt, releasing heat into the storage tank, and using the released heat to maintain the store tank temperature above the molten salt stream freezing point. Further, in the example of FIG. 1B, the method comprises (a) directing a first stream comprising carbon dioxide (CO2) into an absorber comprising a molten salt, (b) in the absorber, contacting the first stream comprising CO2 with the molten salt to yield a carbon-rich molten salt stream with absorbed CO2, (c) directing the carbon-rich molten salt stream from the absorber to a storage tank comprising a headspace, (d) directing a second stream comprising CO2 to the headspace of the storage tank, (e) absorbing at least a portion of CO2 from the second stream into the molten-rich salt stream in the storage tank, (f) releasing heat into storage tank from CO2 absorption into molten-rich salt stream, and (g) maintaining a storage tank temperature above a molten salt stream freezing point by using released heat.

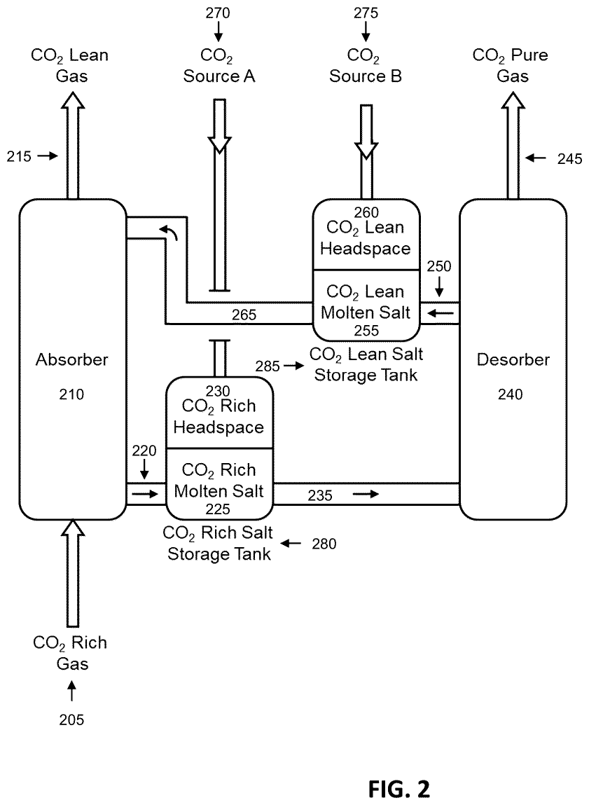

In an example, FIG. 2 shows a process for CO₂ capture. A first stream comprising carbon dioxide (CO2) may first be directed to an absorber comprising molten salt. In some instances, the first stream comprising CO₂ may be output from an industrial process. In some instances, the industrial process may comprise a coal fired power plant, a natural gas fired power plant, an industrial heating facility, a cement plant, a steel mill, a hydrogen production facility, a pulp and paper mill, a waste-to-energy power plant, or a bioenergy power plant. An industrial process described herein may comprise burning a solid fuel, gaseous fuel, or a liquid fuel. Examples of solid fuel may comprise coal, biomass, waste, or refuse, or any combination thereof. Examples of gaseous fuel may comprise natural gas, methane, propane, or refinery gas, or any combination thereof. Examples of liquid fuel may comprise oil, oil-products, petrol, diesel, kerosene, bio-diesel, or any combination thereof.

In some cases, the absorber comprises a molten salt. In some embodiments, the molten salt comprises a formula of AₓB₁₋ₓO_{1.5-x}, wherein A is an ion with a positive charge, and wherein x is greater than or equal to 0.5 and less than or equal to 1.0. The ion may be an alkali metal, alkaline metal, transition metal, or a combination thereof. The ion may also be a lithium, a potassium, a sodium, or a combination thereof.

The first stream comprising carbon dioxide (CO₂) may contact the molten salt in the absorber such that at least a portion of CO₂ from the first stream is absorbed into the molten salt to provide a molten salt stream comprising absorbed CO₂. Absorption of CO₂ into the molten salt may release energy. The molten salt exiting the absorber may be CO₂ rich and at a high temperature, above the freezing point of the molten salt. In some cases, the molten salt stream is directed to a storage tank. The storage tank may comprise a headspace. The headspace may comprise a fluid. The fluid may be a gas, a liquid, or a combination thereof. In some embodiments, the headspace comprises CO₂, an inert gas, or a flue gas, or a combination thereof. In some embodiments, the composition of the gas in the headspace is predominantly a mixture of CO₂ and inert gas. Examples of inert gas may comprise nitrogen or air, or a combination thereof.

In some cases, a second stream comprising CO₂ is directed to the headspace of the storage tank, thus increasing the concentration of CO₂ in the headspace. In some embodiments, at least a portion of CO₂ from the second stream comprising CO₂ may be absorbed into the molten salt stream in the storage tank, thereby resulting in an increased amount of CO₂ in the molten salt stream exiting the storage tank. In some embodiments, the absorption of CO₂ from the second stream comprising CO₂ into the molten salt stream may release heat into the storage tank. In some embodiments, the heat from CO₂ absorption into the molten salt stream may maintain the molten salt stream above its freezing point in the storage tank.

In some instances, the storage tank is a molten salt storage tank. The storage tank may be cylindrical. The storage tank may also be insulated. The volume of the storage tank may be of any size. The size of the storage tank may depend on the size of the carbon capture system. The volume of the storage tank may be about 1 m³ to about 10,000 m³. The volume of the storage tank may be about 1 m³ to about 10 m³, about 1 m³ to about 100 m³, about 1 m³ to about 1,000 m³, about 1 m³ to about 10,000 m³, about 10 m³ to about 100 m³, about 10 m³ to about 1,000 m³, about 10 m³ to about 10,000 m³, about 100 m³ to about 1,000 m³, about 100 m³ to about 10,000 m³, or about 1,000 m³ to about 10,000 m³. The volume of the storage tank may be about 1 m³, about 10 m³, about 100 m³, about 1,000 m³, or about 10,000 m³. The volume of the storage tank may be at least about 1 m³, about 10 m³, about 100 m³, or about 1,000 m³. The volume of the storage tank may be at most about 10 m³, about 100 m³, about 1,000 m³, or about 10,000 m³.

In some instances, the volume of the storage tank is at least 10% the sum volume of the integrated carbon capture and thermochemical energy storage system. In some instances, the volume of the storage tank can be about 5 times greater or more than the sum total volume of molten salt in the integrated carbon capture and thermochemical energy storage system. In some instances, the volume of the storage tank can be about 20 times greater or more than the sum total volume of molten salt in the integrated carbon capture and thermochemical energy storage system. In some instances, the volume of the storage tank

can be about 100 times greater or more than the sum total volume of molten salt in the integrated carbon capture and thermochemical energy storage system. In some instances, the volume of the storage tank [280, 380] can be about 200 times greater or more than the sum total volume of molten salt in the integrated carbon capture and thermochemical energy storage system.

In some embodiments, the pressure in the storage environment is maintained above atmospheric pressure. This may prevent pulling a vacuum in the storage tank [280, 380] as the tank is drained. In some embodiments, the total pressure in the storage tank [280, 380] may be greater than 1 bar, greater than 2 bar, or greater than 5 bar.

In some embodiments, the concentration of CO₂ in the storage tank is about 0.1 mol or more per kilogram of the molten salt. n some embodiments, the concentration of CO2 in the storage tank is about 0.2 moles/kg of molten salt to about 5 moles/kg of molten salt. In some embodiments, the concentration of CO2 in the storage tank is about 0.2 moles/kg of molten salt to about 0.3 moles/kg of molten salt, about 0.2 moles/kg of molten salt to about 0.4 moles/kg of molten salt, about 0.2 moles/kg of molten salt to about 0.5 moles/kg of molten salt, about 0.2 moles/kg of molten salt to about 0.6 moles/kg of molten salt, about 0.2 moles/kg of molten salt to about 0.7 moles/kg of molten salt, about 0.2 moles/kg of molten salt to about 1 mol/kg of molten salt, about 0.2 moles/kg of molten salt to about 2 moles/kg of molten salt, about 0.2 moles/kg of molten salt to about 5 moles/kg of molten salt, about 0.3 moles/kg of molten salt to about 0.4 moles/kg of molten salt, about 0.3 moles/kg of molten salt to about 0.5 moles/kg of molten salt, about 0.3 moles/kg of molten salt to about 0.6 moles/kg of molten salt, about 0.3 moles/kg of molten salt to about 0.7 moles/kg of molten salt, about 0.3 moles/kg of molten salt to about 1 mol/kg of molten salt, about 0.3 moles/kg of molten salt to about 2 moles/kg of molten salt, about 0.3 moles/kg of molten salt to about 5 moles/kg of molten salt, about 0.4 moles/kg of molten salt to about 0.5 moles/kg of molten salt, about 0.4 moles/kg of molten salt to about 0.6 moles/kg of molten salt, about 0.4 moles/kg of molten salt to about 0.7 moles/kg of molten salt, about 0.4 moles/kg of molten salt to about 1 mol/kg of molten salt, about 0.4 moles/kg of molten salt to about 2 moles/kg of molten salt, about 0.4 moles/kg of molten salt to about 5 moles/kg of molten salt, about 0.5 moles/kg of molten salt to about 0.6 moles/kg of molten salt, about 0.5 moles/kg of molten salt to about 0.7 moles/kg of molten salt, about 0.5 moles/kg of molten salt to about 1 mol/kg of molten salt, about 0.5 moles/kg of molten salt to about 2 moles/kg of molten salt, about 0.5 moles/kg of molten salt to about 5 moles/kg of molten salt, about 0.6 moles/kg of molten salt to about 0.7 moles/kg of molten salt, about 0.6 moles/kg of molten salt to about 1 mol/kg of molten salt, about 0.6 moles/kg of molten salt to about 2 moles/kg of molten salt, about 0.6 moles/kg of molten salt to about 5 moles/kg of molten salt, about 0.7 moles/kg of molten salt to about 1 mol/kg of molten salt, about 0.7 moles/kg of molten salt to about 2 moles/kg of molten salt, about 0.7 moles/kg of molten salt to about 5 moles/kg of molten salt, about 1 mol/kg of molten salt to about 2 moles/kg of molten salt, about 1 mol/kg of molten salt to about 5 moles/kg of molten salt, or about 2 moles/kg of molten salt to about 5 moles/kg of molten salt. In some embodiments, the concentration of CO2 in the storage tank is about 0.2 moles/kg of molten salt, about 0.3 moles/kg of molten salt, about 0.4 moles/kg of molten salt, about 0.5 moles/kg of molten salt, about 0.6 moles/kg of molten salt, about 0.7 moles/kg of molten salt, about 1 mol/kg of molten salt, about 2 moles/kg of molten salt, or about 5 moles/kg of molten salt. In some embodiments, the concentration of CO2 in the storage tank is at least about 0.2 moles/kg of molten salt, about 0.3 moles/kg of molten salt, about 0.4 moles/kg of molten salt, about 0.5 moles/kg of molten salt, about 0.6 moles/kg of molten salt, about 0.7 moles/kg of molten salt, about 1 mol/kg of molten salt, or about 2 moles/kg of molten salt. In some embodiments, the concentration of CO2 in the storage tank is at most about 0.3 moles/kg of molten salt, about 0.4 moles/kg of molten salt, about 0.5 moles/kg of molten salt, about 0.6 moles/kg of molten salt, about 0.7 moles/kg of molten salt, about 1 mol/kg of molten salt, about 2 moles/kg of molten salt, or about 5 moles/kg of molten salt.

In some embodiments, the second stream comprising CO₂ may be at a temperature of at least 100° C. In some embodiments, the second stream comprising CO₂ may be at a temperature of at least 200° C. In some embodiments, the second stream comprising CO₂ may be at a temperature of at least 300° C. In some embodiments, the second stream comprising CO₂ may be at a temperature of at least 600° C.

In some embodiments, the method may further comprise determining a demand for the energy that is released upon absorption of CO2 into molten salt. The energy demand can come from the on-site industrial process or an external energy-intensive process. The demand for energy may come from a CO₂ producing system. Demand can be based on a percentage with respect to the CO₂ producing system's thermal input. Demand may come from an electric grid. Demand may come from an off-site industrial site. In some cases, demand for power fluctuates over time depending on consumer demand. For example, if demand comes from an electric grid, demand may be less during the nighttime when most energy consumers are sleeping. In other examples, if demand comes from an electric grid, demand may be more during the daytime when most energy consumers are awake.

In some instances, the method comprises, when the demand for energy is less than a threshold value, directing the molten salt stream to a desorber. For example, the desorption of CO2 from the molten salt stream may comprise an endothermic reaction.

In some instances, the method comprises, when the demand for energy is greater than a threshold value, directing the molten salt stream to an absorber. For example, the absorption of CO2 into the molten salt stream may comprise an exothermic reaction.

In some instances, the demand is above the threshold value at a first timepoint. In some instances, the demand is below the threshold value at a second timepoint. For example, the first time point may occur before the second timepoint. In further examples, the first time point may occur at noontime and the second time point may occur afternoon. In other examples, the first time point may occur after the second timepoint. In further examples, the second time point may occur at noontime and the first time point may occur afternoon. In even further examples, the first time point may occur at any time (e.g., first day 12 AM to second day 12 AM). In even further examples, the second time point may occur at any time (e.g., first day 12 AM to second day 12 AM).

In some instances, the thermochemical energy storage systems' ability to increase and decrease the thermal output of the plant is more than 1% of the CO₂ producing system's thermal input. In some instances, the thermochemical energy storage systems' ability to increase and decrease the thermal output of the plant is more than 5% of the CO₂ producing system's thermal input In some instances, the thermochemical energy storage systems' ability to increase and decrease the thermal output of the plant is more than 10% of the CO₂ producing system's thermal input In some instances, the thermochemical energy storage systems' ability to increase and decrease the thermal output of the plant is more than 20% of the CO₂ producing system's thermal input

In some embodiments, the method may further comprise, when the abovementioned demand for energy is below a threshold value, directing the molten salt stream comprising CO₂ from the storage tank to a desorber. In some embodiments, CO₂ may desorb from the molten salt stream in the desorber through an endothermic chemical reaction, yielding a third stream comprising CO₂ and an additional molten salt stream.

In some instances, the additional molten salt stream may be directed to an additional storage tank comprising a headspace. In some embodiments, a fourth stream comprising CO₂ may be directed to the headspace of the additional storage tank. The fourth stream comprising CO₂ may be optimally directed to the headspace by bubbling the fourth stream through the molten salt. The fourth stream comprising CO₂ may be directed to the headspace by introducing the fourth stream directly into the headspace. In some embodiments, at least a portion of CO₂ from the fourth stream may be absorbed into the additional molten salt stream in the additional storage tank, thereby resulting in an increased amount of CO₂ in the molten salt stream exiting the storage tank. In some embodiments, the absorption of CO₂ from the fourth stream comprising CO₂ into the additional molten salt stream may release heat into the additional storage tank. In some embodiments, the heat from CO₂ absorption into the additional molten salt stream may maintain the additional molten salt stream above its freezing point in the additional storage tank.

Notably, increasing the partial pressure of CO₂ in the headspace of storage tanks may drive the exothermic forward reaction between CO₂ and the molten salt, thereby generating heat to help maintain the required temperature in the storage tank. Taken together, the partial pressure of CO₂ in storage tank headspaces may be manipulated to maintain the temperature of the storage tank.

The partial pressure of CO₂ in storage tank headspaces can be increased in several ways. In a first example, the partial pressure of CO₂ in storage tank headspaces can be raised by increasing the total pressure in the storage tanks. In a second example, the partial pressure of CO₂ in storage tank headspaces can be raised by introducing gas streams comprising CO₂ directly into storage tank headspaces. In a third example, the partial pressure of CO₂ in storage tank headspaces can be optimally raised by bubbling gas streams comprising CO₂ through the molten salt stream in the storage tanks.

In some instances, the method may further comprise, when the aforementioned demand for energy is above a threshold value, directing the additional molten salt stream

from the additional storage tank to the absorber. In some instances, the method may further comprise, when the aforementioned demand for energy is above a threshold value, increasing the level of CO₂ rich molten salt in the storage tank until the capacity of the storage tank is reached. The increasing magnitude of asymmetric flows may be supported by increasing the volume of the storage tanks used in the integrated carbon capture and thermochemical energy storage system. Taken together, the integration of the thermochemical energy storage system into the carbon capture system can be enabled by manipulating the volume of stored molten salt within the storage tanks. In this way the combined system may store energy for load-following purposes while continuing to capture CO₂ at a constant rate from a CO₂ producing system.

In some embodiments, the additional molten salt stream may contact the first stream comprising CO₂ in the absorber. In some instances, at least a portion of the third stream comprising CO₂ may be directed to the headspace of the storage tank.

In some embodiments, the molten salt stream may comprise a first concentration of CO₂ and the additional molten salt stream may comprise a second concentration of CO₂. In some instances, the first concentration of CO₂ may be greater than the second concentration of CO₂.

The storage tanks may be thermally insulated to minimize the risk of the molten salt freezing. In some instances, salt freezing may first occur at the edges of the storage tank which will aid in increasing the insulating layer. In some instances, the storage tanks may be maintained at a high temperature, above the freezing point of the molten salt. In some instances, the storage tanks may be maintained at a high temperature, above 400° C. In some instances, the storage tanks may be maintained at a high temperature, above 500° C. In some instances, the storage tanks may be maintained at a high temperature, above 600° C.

In some instances, less than 10% of the third stream comprising CO₂ may be directed to the headspace of the storage tank. In some instances, less than 5% of the third stream comprising CO₂ may be directed to the headspace of the storage tank. In some instances, less than 1% of the third stream comprising CO₂ may be directed to the headspace of the storage tank.

In some instances, the second stream comprising CO₂ may comprise at least a portion of the third stream comprising CO₂. In some instances, the fourth stream comprising CO₂ may comprise at least a portion of the third stream comprising CO₂.

In some embodiments, the method may further comprise directing at least a portion of the first stream comprising CO₂ to the headspace of the storage tank such that the headspace and the molten salt stream are in chemical equilibrium. In some embodiments, the level of the molten salt stream in the storage tank may be controlled in an absence of pressurizing or in an absence of depressurizing the storage tank.

In some embodiments, the method may further comprise directing at least a portion of the third stream comprising CO₂ to the headspace of the additional storage tank such that the headspace and the additional molten salt stream are in chemical equilibrium. In some embodiments, the level of the additional molten salt stream in the additional storage tank may be controlled in an absence of pressurizing or in an absence of depressurizing the additional storage tank.

In some embodiments, the amount of CO₂ in the molten salt stored in the storage tank and the amount of CO₂ in the additional storage tank may be greater than the average amount of CO₂ in the molten salt stream and the additional molten salt stream throughout the system.

In some embodiments, the concentration of CO₂ in the headspace may be less than the concentration of CO₂ in the first stream comprising CO₂. In some embodiments, the concentration of CO₂ in the headspace may be less than 50% of the concentration of CO₂ in the first stream comprising CO₂. In some embodiments, the concentration of CO₂ in the headspace may be less than 20% of the concentration of CO₂ in the first stream comprising CO₂. In some embodiments, the concentration of CO₂ in the headspace may be less than 10% of the concentration of CO₂ in the first stream comprising CO₂.

In some embodiments described herein, the molten salt stream may be transferred using one or more pumps. In some embodiments, the pumps may move molten material between the storage tanks and the CO₂ producing system. The flowrate of molten salt through a transfer pump may be about 1 liter/minute to about 1,000 liters/minute. The flowrate of molten salt through a transfer pump may be about 1 liter/minute to about 10 liters/minute, about 1 liter/minute to about 100 liters/minute, about 1 liter/minute to about 1,000 liters/minute, about 10 liters/minute to about 100 liters/minute, about 10 liters/minute to about 1,000 liters/minute, or about 100 liters/minute to about 1,000 liters/minute. The flowrate of molten salt through a transfer pump may be about 1 liter/minute, about 10 liters/minute, about 100 liters/minute, or about 1,000 liters/minute. The flowrate of molten salt through a transfer pump may be at least about 1 liter/minute, about 10 liters/minute, or about 100 liters/minute. The flowrate of molten salt through a transfer pump may be at most about 10 liters/minute, about 100 liters/minute, or about 1,000 liters/minute. In some embodiments, the pumps may also circulate material internal to the storage tanks to equilibrate the temperature internal to the storage tanks. In some instances, the one or more pumps may operate at a temperature of at least 400° C. In some instances, the one or more pumps may operate at a temperature of at least 600° C.

### Carbon Capture System

A carbon capture system may be a component of a high temperature system used in an industrial process. In some embodiments, the high temperature system may be built or constructed with a carbon capture system component. In some embodiments, a carbon capture system for the absorption and desorption of carbon dioxide as described herein may be retroactively fitted into a system, particularly a high temperature system component, used in an industrial process. For example, a desorber of a carbon capture system may be integrated into a high temperature system. In some embodiments, a desorber integrated with a high temperature system may further comprise a tank to allow space for the carbon containing material to desorb from the molten borate salt.

In some examples, the carbon capture system is configured such that the heat generated in a high temperature system (e.g., a boiler) is transferred to a desorber in the carbon capture system. In some embodiments, the heat of reaction is generated in the convection section of the carbon capture system upon absorption of carbon containing material into a stream comprising molten salt. In some embodiments, the heat generated may be passed to a desorber to regenerate the molten salt and carbon containing material. In some embodiments, the desorbed carbon containing material may be high purity carbon containing material (e.g., high purity carbon dioxide).

A carbon capture system may comprise an absorber. The absorber may be positioned within, adjacent to, or proximal toa high temperature system of an industrial process. An absorber may comprise one or more types of molten salt, where the molten salt is used to sequester (e.g., absorb carbon dioxide). The absorber may operate at a temperature of at least 200° C., 300° C., 400° C., 500° C., 600° C., 700° C., 800° C., 900° C., 1000° C., 1200° C., or any other temperature within the preceding range.

Molten salt in an absorber may capture at least about 40%, 50%, 60%, 70%, 80%, 90%, 95%, 99%, or 100% of carbon containing material (e.g., carbon dioxide) that it contacts. In some embodiments, an absorber may capture at least about 40%, 50%, 60%, 70%, 80%, 90%, 95%, 99%, or 100% of carbon containing material (e.g., carbon dioxide) that it contacts. The absorber may capture at least about 50% of the carbon containing material it contacts, about 75% of the carbon containing material it contacts, about 80% of the carbon containing material it contacts, about 85% of the carbon containing material it contacts, about 90% of the carbon containing material it contacts, or about 95% of the carbon containing material it contacts.

A carbon capture system may comprise a desorber. The desorber may be positioned within, adjacent to, or proximal to a high temperature system A desorber may be used to release, or desorb, carbon dioxide from a molten salt. The desorber may have a temperature of at least 200° C., 300° C., 400° C., 500° C., 600° C., 700° C., 800° C., 900° C., 1000° C., 1200° C., 1400° C., 1600° C., 2000° C., or any other temperature within the preceding range.

The desorber may release about 10% of the carbon containing material absorbed within the stream comprising molten salt, about 20% of the carbon containing material absorbed within the stream comprising molten salt, about 30% of the carbon containing material absorbed within the stream comprising molten salt, about 40% of the carbon containing material absorbed within the stream comprising molten salt, about 50% of the carbon containing material absorbed within the stream comprising molten salt, about 60% of the carbon containing material absorbed within the stream comprising molten salt, about 70% of the carbon containing material absorbed within the stream comprising molten salt, about 80% of the carbon containing material absorbed within the stream comprising molten salt, about 85% of the carbon containing material absorbed within the stream comprising molten salt, about 90% of the carbon containing material absorbed within the stream comprising molten salt, about 95% of the carbon containing material absorbed within the stream comprising molten salt, or about 99% of the carbon containing material absorbed within the stream comprising molten salt, or about 100% of the carbon containing material absorbed within the stream comprising molten salt. In some embodiments, the desorber may release about 10% to about 100% of the carbon containing material absorbed within the stream comprising molten salt. In some embodiments, the desorber may release about 40% to about 100% of the carbon containing material absorbed within the stream comprising molten salt. For example, a carbon rich stream comprising molten salt may comprise about 50% carbon dioxide and comprise about 30% carbon dioxide in the carbon lean stream comprising molten salt upon desorption of carbon dioxide, thereby effectively releasing about 40% of the carbon dioxide absorbed in the stream comprising molten salt.

In some embodiments, the desorber may have a temperature that is higher than the absorber. The temperature difference between an absorber and a desorber may be at least about 100° C., 200° C., 300° C., 400° C., 500° C., 600° C., or more. In some embodiments, the higher temperature of the desorber (in comparison to the absorber) may facilitate desorption of carbon dioxide from a molten salt.

In some embodiments, a carbon capture system may comprise a packed bed, tank, heat exchanger, or a combination thereof. In some embodiments, a carbon capture system may comprise a packed bed and a heat exchanger. In some embodiments, a carbon capture system may comprise a tank and a heat exchanger. In some embodiments, the desorber may comprise packing material. In some embodiments, the desorber may not comprise packing material. The packing material may be a part of a packed bed. The packing material may comprise random packing, structured packing, or a combination thereof. A packed bed may lengthen the duration of time a carbon rich stream resides in the desorber to provide more opportunity for carbon containing material to desorb from the carbon rich stream. In some embodiments, the absorber may comprise packing material. The packing material may be a part of a packed bed. The packing material may comprise random packing, structured packing, or a combination thereof. In some embodiments, the packing material may provide a high surface area for the molten-salt stream to interact with. In some embodiments, the packing material may reduce pressure drop as a stream comprising molten salt passes through the packed bed. In some embodiments, the packing material may comprise a low-cost material. A packing material may comprise a conductive material. In some embodiments, a packing material may comprise a metal, metal alloy, ceramic material, or a combination thereof.

In some embodiments, the carbon capture system may comprise a tank. The tank may comprise a space to allow the carbon containing material released from the carbon rich stream to reside (e.g., CO₂ drum or molten salt drum). In some embodiments, the tank is a flash tank. In some embodiments, the tank is a drum. In some embodiments the tank may contain a mixture of liquid molten salt (e.g., carbon lean molten salt and carbon rich molten salt) and gaseous carbon containing material. In some embodiments, at any given time during the desorption process, the tank may be at least 10% liquid filled, at least 20% liquid filled, at least 50% liquid filled, at least 80% liquid filled, or more. In some embodiments, the tank may comprise a riser tube. In some embodiments the tank may comprise a downcomer tube. In some embodiments the tank may comprise a cyclone. In some embodiments the tank may comprise baffles. A large tank may increase the residence time of the molten salt in the tank, thereby achieving a greater degree of desorption. A large tank may reduce the velocity of a molten salt stream and prevent entrainment of a molten salt stream into the carbon containing material gas stream. A small tank may reduce the residence time of the molten salt in the tank. A small tank may increase heat transfer from the radiant section. A small tank may reduce the total amount of molten salt required in the system. In some embodiments, the residence time of molten salt in the tank may be at least 30 seconds, at least 1 minute, at least 2 minutes, at least 5 minutes, at least 10 minutes, at least 20 minutes. A molten salt stream in a large tank may have a residence time of at least 5 minutes, at least 10 minutes, at least 20 minutes, or more. A molten salt stream in a small tank may have a residence time of at most about 10 minutes, about 5 minutes, about 2 minutes, about 1 minute, about 30 seconds, or less. In some embodiments, a tank may be exposed to hot flue gas. In some embodiments, the pressure of desorbed carbon containing gas in the tank may be controlled by a downstream fan. In some embodiments, the fan may rotate upon contact with a carbon dioxide draft.

In some embodiments, transfer pumps may be used to facilitate transport of streams within a carbon capture system. In some embodiments, a transfer pump may be used to transport any stream to a location within the carbon capture system.

In some embodiments, a transfer pump may operate with an outlet absolute pressure of at least 0.5 bar, 1 bar, 2 bar, 3 bar, 4 bar, 5 bar, 6 bar, 7 bar, 8 bar, 9 bar, 10 bar, 15 bar, 20 bar, 30 bar, 40 bar, 50 bar, 60 bar, 70 bar, 80 bar, 90 bar, 100 bar, 120 bar, 150 bar, 200 bar, any other pressure within the preceding range, or more.

In some embodiments, a transfer pump may operate at a temperature of at least about 300° C., 400° C., 500° C., 600° C., 700° C., 800° C., 900° C., 1000° C., 1200° C., 1400° C., 1600° C., 2000° C., any other temperature within the preceding range, or more.

In some embodiments, the carbon capture system may comprise a heat exchanger. A heat exchanger positioned in a path between the absorber and the desorber may be used to raise or lower the temperature of a stream

In some embodiments, the heat exchanger may raise the temperature of a molten salt stream at least about 50° C., 100° C., 150° C., 200° C., 300° C., 350° C., 400° C., or more. In some embodiments, the heat exchanger may raise the temperature of the molten salt stream to about the temperature of the desorber. In some embodiments, the heat exchanger may raise the temperature of the molten rich salt stream to about the temperature less than that of the desorber by about 20° C., 50° C., 80° C., 100° C., 150° C., 200° C., 250° C., 300° C., or more.

In some embodiments, the heat exchanger may lower the temperature of the molten salt stream at least about 50° C., 100° C., 150° C., 200° C., 300° C., 350° C., 400° C., or more Lowering the temperature of the molten salt stream may also prevent damage to storage tanks or transfer pumps if they are not constructed of material durable to the high temperatures the streams may reach.

In some embodiments, the heat exchanger may be positioned inside of, adjacent to, or proximal to a high temperature system or outside of a high temperature system.

In some embodiments, the carbon capture system may comprise one or more transfer pumps to transfer molten salt streams. In some embodiments, a transfer pump may operate at a pressure of at least about 0.1 bar, 1 bar, 2 bar, 3 bar, 4 bar, 5 bar, 6 bar, 7 bar, 8 bar, 9 bar, 10 bar, 20 bar, 30 bar, 40 bar, 50 bar, or more. In some embodiments, a transfer pump may operate at a pressure from about 1 bar to about 10 bar.

In another aspect, the present disclosure provides a method for retrofitting an industrial process with a carbon capture system, comprising: (a) providing an industrial process; and (b) retrofitting the industrial process with the carbon capture system, wherein the carbon capture system uses a molten salt to (i) capture carbon dioxide and (ii) desorb the carbon dioxide to yield desorbed CO₂ and a stream comprising the molten salt, wherein the stream comprises less than 50 mol % steam.

### Molten Salt Streams

### Molten Borate Salts

The carbon capture system may use a molten salt. The molten salt may comprise a molten borate salt. The borate salt may comprise a formula of AₓB₁₋ₓO_{1.5-x}. In such formulas, “A” refers to an alkali metal, “B” refers to boron, “O” refers to oxygen, and “x” is a value between 0 and 1.

In some embodiments, “x” is a number between 0 and 1. In some embodiments, “x” is about 0.4, 0.45, 0.5, 0.55, 0.6, 0.65, 0.7, 0.75, 0.8, 0.85, 0.9, 0.91, 0.92, 0.93, 0.94, 0.95, 0.96, 0.97, 0.98, or 0.99. In some embodiments, “x” is a number between about 0.25 and about 0.98. In some embodiments, “x” is a number between about 0.3 and about 0.95. In some embodiments, “x” is a number between about 0.5 and about 0.95. In some embodiments, “x” is a number between about 0.6 and about 0.9. In some embodiments “x” is about 0.75.

In some embodiments, “A” comprises alkali metal. An alkali metal may be lithium (Li), sodium (Na), potassium (K), rubidium (Rb), cesium (Cs), or francium (Fr). In some embodiments, “A” is lithium. In some embodiments, “A” is sodium. In some embodiments, “A” is potassium. In some embodiments, “A” is rubidium. In some embodiments, “A” is cesium. In some embodiments, “A” is francium. In some embodiments, “A” may comprise an alkaline earth metal. An alkali earth metal may be beryllium (Be), strontium (Sr), calcium (Ca), magnesium (Mg), barium (Ba), or radium (Ra). In some embodiments, “A” may be any cation comprising a positive charge of +1. In some embodiments, “A” may comprise a transition metal with a +1 charge (e.g., copper, silver, or any other transition metal). In some embodiments “A” may comprise a transition metal. A transition metal may be scandium (Sc), yttrium (Y), lanthanum (La), actinium (Ac), titanium (Ti), zirconium (Zr), hafnium (Hf), rutherfordium (Rf), vanadium (V), niobium (Nb), tantalum (Ta), dubnium (Db), chromium (Cr), molybdenum (Mo), tungsten (W), seaborgium (Sg), manganese (Mn), technetium (Tc), rhenium (Re), bohrium (Bh), iron (Fe), ruthenium (Ru), osmium (Os), hassium (Hs), cobalt (Co), rhodium (Rh), iridium (Ir), meitnerium (Mt), nickel (Ni), palladium (Pd), platinum (Pt), darmstadtium (Ds), copper (Cu), silver (Ag), gold (Au), roentgenium (Rg), zinc (Zn), cadmium (Cd), mercury (Hg), or copernicium (Cn). In some embodiments, the borate salt may comprise a mixture of metals. A may comprise a mixture of alkali metals, alkaline earth metals, transition metals, or any combination thereof. For example the formula for the borate salt may comprise (A¹_{y}A²_{1-y})ₓB₁₋ₓO_{1.5-x}, where A¹ and A² are each a separate “A” as described herein, “y” is a number between 0 and 1, and “x” is a number between 0 and 1. In some embodiments, a borate salt may comprise a mixture of lithium and sodium. In some embodiments A¹ is lithium and A² is sodium. In some embodiments A¹ is lithium, A² is sodium, y is 0.4, and x is 0.75. In some embodiments A¹ is lithium, A² is sodium, y is 0.5, and x is 0.75. In some embodiments A¹ is lithium, A² is sodium, y is 0.33, and x is 0.75. In some embodiments, the borate salt may comprise a composition of Na_{0.75}B_{0.25}O_{0.75}, (Li_{0.5}Na_{0.5})_{0.75}B_{0.25}O_{0.75}, (Li_{0.4}Na_{0.6})_{0.75}B_{0.25}O_{0.75}, (Li_{0.3}Na_{0.7})_{0.75}B_{0.25}O_{0.75}, (Li_{0.2}Na_{0.8})_{0.75}B_{0.25}O_{0.75}, (Li_{0.1}Na_{0.9})_{0.75}B_{0.25}O_{0.75}, (Li_{0.33}Na_{0.33}K_{0.33})_{0.75}B_{0.25}O_{0.75}, (Li_{0.4}Na_{0.5}K_{0.1})_{0.75}B_{0.25}O_{0.75}, (Li_{0.7}Na_{0.3})_{0.5}B_{0.5}O_{1.0}, (Li_{0.5}Na_{0.5})_{0.83}B_{0.17}O_{0.67}, (Li_{0.7}Na_{0.3})_{0.83}B_{0.17}O_{0.67}, or (Li_{0.3}Na_{0.7})_{0.83}B_{0.17}O_{0.67}.

In some embodiments, a borate salt may comprise an impurity or a contaminant. For example, the impurity may comprise Iron (Fe), Chromium (Cr), Nickel (Ni), Manganese (Mn), Molybdenum (Mo), Cobalt (Co), Vanadium (V), Copper (Cu), Zinc (Zn), Aluminum (Al), Titanium (Ti), Cadmium (Cd), Mercury (Hg), Potassium (K), Magnesium (Mg), Silicon (Si), Phosphorus (P), and Sulfur(S), or any other contaminants. A quantity of an impurity in the borate salt may be at most about 30 weight percent (wt %), 20 wt %, 10 wt %, 5 wt %, 2 wt %, 1 wt %, 0.5 wt %, 0.1 wt %, 0.08 wt %, 0.05 wt %, 0.01 wt %, 0.005 wt %, 0.001 wt %, or less.

In some embodiments, a borate salt comprising the formula A_{0.75}B_{0.25}O_{0.75} may be represented as A₃BO₃. In some embodiments, a borate salt comprising the formula A_{0.5}B_{0.5}O_{1.0} may be represented as ABO₂. In some embodiments, a borate salt comprising the formula A_{0.83}B_{0.17}O_{0.67} may be represented as A₅BO₄.

### Molten Salt Streams

The carbon capture system may comprise one or more streams comprising a molten salt. In some embodiments, each stream of the one or more streams may comprise a molten borate salt. In some embodiments, the system or process may comprise a plurality of streams, where the composition of at least one stream of the plurality of streams is different.

A molten salt stream may refer to a stream generated from contacting the gaseous carbon containing material with molten salt (e.g., the molten salt stream) in an absorber. An additional molten salt stream may refer to a stream subsequent to desorption of carbon containing material. The molten salt stream may be a carbon rich stream. The additional molten salt stream may be a carbon lean stream. In some embodiments, the concentration of carbon in each stream is relative. For example, a carbon lean stream (e.g., the additional molten salt stream) may comprise a small quantity of carbon containing material, however, the concentration of carbon containing material in the additional molten salt stream is lower than the concentration of carbon containing material in the carbon rich stream (e.g., the molten salt stream). Molten salt in the absorber may be derived from a regenerated stream (e.g., the additional molten salt stream). Molten salt in the absorber may comprise a regenerated stream (e.g., the additional molten salt stream) in addition to fresh molten salt. The fresh molten salt may be combined with the a regenerated stream (e.g., the additional molten salt stream). The concentration of carbon containing material of the molten salt stream and the additional molten salt stream may be the same or different.

The molten salt stream leaving the absorber may be referred to as a “carbon rich” molten salt stream due to the CO₂ captured from the absorber. In some cases, after leaving the absorber, a molten salt stream may have a concentration of carbon-containing material (CO₂, for example) of about 0.2 mol/kg of molten salt to about 10 mol/kg of molten salt. In some cases, after leaving the absorber, a molten salt stream may have a concentration of carbon-containing material of about 0.2 mol/kg of molten salt to about 0.5 mol/kg of molten salt, about 0.2 mol/kg of molten salt to about 1 mol/kg of molten salt, about 0.2 mol/kg of molten salt to about 2 mol/kg of molten salt, about 0.2 mol/kg of molten salt to about 5 mol/kg of molten salt, about 0.2 mol/kg of molten salt to about 6 mol/kg of molten salt, about 0.2 mol/kg of molten salt to about 10 mol/kg of molten salt, about 0.5 mol/kg of molten salt to about 1 mol/kg of molten salt, about 0.5 mol/kg of molten salt to about 2 mol/kg of molten salt, about 0.5 mol/kg of molten salt to about 5 mol/kg of molten salt, about 0.5 mol/kg of molten salt to about 6 mol/kg of molten salt, about 0.5 mol/kg of molten salt to about 10 mol/kg of molten salt, about 1 mol/kg of molten salt to about 2 mol/kg of molten salt, about 1 mol/kg of molten salt to about 5 mol/kg of molten salt, about 1 mol/kg of molten salt to about 6 mol/kg of molten salt, about 1 mol/kg of molten salt to about 10 mol/kg of molten salt, about 2 mol/kg of molten salt to about 5 mol/kg of molten salt, about 2 mol/kg of molten salt to about 6 mol/kg of molten salt, about 2 mol/kg of molten salt to about 10 mol/kg of molten salt, about 5 mol/kg of molten salt to about 6 mol/kg of molten salt, about 5 mol/kg of molten salt to about 10 mol/kg of molten salt, or about 6 mol/kg of molten salt to about 10 mol/kg of molten salt. In some cases, after leaving the absorber, a molten salt stream may have a concentration of carbon-containing material of about 0.2 mol/kg of molten salt, about 0.5 mol/kg of molten salt, about 1 mol/kg of molten salt, about 2 mol/kg of molten salt, about 5 mol/kg of molten salt, about 6 mol/kg of molten salt, or about 10 mol/kg of molten salt. In some cases, after leaving the absorber, a molten salt stream may have a concentration of carbon-containing material of at least about 0.2 mol/kg of molten salt, about 0.5 mol/kg of molten salt, about 1 mol/kg of molten salt, about 2 mol/kg of molten salt, about 5 mol/kg of molten salt, or about 6 mol/kg of molten salt. In some cases, after leaving the absorber, a molten salt stream may have a concentration of carbon-containing material of at most about 0.5 mol/kg of molten salt, about 1 mol/kg of molten salt, about 2 mol/kg of molten salt, about 5 mol/kg of molten salt, about 6 mol/kg of molten salt, or about 10 mol/kg of molten salt.

The molten salt stream leaving the desorber may be referred to as a “carbon lean” molten salt stream due to the CO₂ released in the desorber. In some cases, after leaving the desorber, a molten salt stream may have a concentration of carbon-containing material of about 0.001 mol/kg of molten salt to about 5 mol/kg of molten salt. In some cases, after leaving the desorber, a molten salt stream may have a concentration of carbon-containing material of about 0.001 mol/kg of molten salt to about 0.01 mol/kg of molten salt, about 0.001 mol/kg of molten salt to about 0.1 mol/kg of molten salt, about 0.001 mol/kg of molten salt to about 0.5 mol/kg of molten salt, about 0.001 mol/kg of molten salt to about 1 mol/kg of molten salt, about 0.001 mol/kg of molten salt to about 2 mol/kg of molten salt, about 0.001 mol/kg of molten salt to about 5 mol/kg of molten salt, about 0.01 mol/kg of molten salt to about 0.1 mol/kg of molten salt, about 0.01 mol/kg of molten salt to about 0.5 mol/kg of molten salt, about 0.01 mol/kg of molten salt to about 1 mol/kg of molten salt, about 0.01 mol/kg of molten salt to about 2 mol/kg of molten salt, about 0.01 mol/kg of molten salt to about 5 mol/kg of molten salt, about 0.1 mol/kg of molten salt to about 0.5 mol/kg of molten salt, about 0.1 mol/kg of molten salt to about 1 mol/kg of molten salt, about 0.1 mol/kg of molten salt to about 2 mol/kg of molten salt, about 0.1 mol/kg of molten salt to about 5 mol/kg of molten salt, about 0.5 mol/kg of molten salt to about 1 mol/kg of molten salt, about 0.5 mol/kg of molten salt to about 2 mol/kg of molten salt, about 0.5 mol/kg of molten salt to about 5 mol/kg of molten salt, about 1 mol/kg of molten salt to about 2 mol/kg of molten salt, about 1 mol/kg of molten salt to about 5 mol/kg of molten salt, or about 2 mol/kg of molten salt to about 5 mol/kg of molten salt. In some cases, after leaving the desorber, a molten salt stream may have a concentration of carbon-containing material of about 0.001 mol/kg of molten salt, about 0.01 mol/kg of molten salt, about 0.1 mol/kg of molten salt, about 0.5 mol/kg of molten salt, about 1 mol/kg of molten salt, about 2 mol/kg of molten salt, or about 5 mol/kg of molten salt. In some cases, after leaving the desorber, a molten salt stream may have a concentration of carbon-containing material of at least about 0.001 mol/kg of molten salt, about 0.01 mol/kg of molten salt, about 0.1 mol/kg of molten salt, about 0.5 mol/kg of molten salt, about 1 mol/kg of molten salt, or about 2 mol/kg of molten salt. In some cases, after leaving the desorber, a molten salt stream may have a concentration of carbon-containing material of at most about 0.01 mol/kg of molten salt, about 0.1 mol/kg of molten salt, about 0.5 mol/kg of molten salt, about 1 mol/kg of molten salt, about 2 mol/kg of molten salt, or about 5 mol/kg of molten salt. In some embodiments, the carbon lean stream may comprise no carbon containing material.

As described herein, the carbon lean stream comprises a lower concentration of carbon containing material when compared to the concentration of carbon containing material in a carbon rich stream.

### Carbon Capture and Molten Salt Regeneration

A process for absorbing carbon dioxide in a molten salt and regenerating the molten salt and carbon dioxide in a desorber are described herein. An absorber may be used to contact a gaseous carbon containing material (e.g., carbon dioxide, carbon monoxide) with a molten salt, described elsewhere herein, thereby transferring the gaseous carbon containing material to a liquid stream of the molten salt. A stream comprising absorbed carbon containing material may be referred to as a carbon rich stream or a rich stream herein. The rich stream is directed to a desorber where the molten salt may be regenerated and a stream comprising desorbed carbon containing material may be further cooled, compressed, and/or prepared for export elsewhere in the system or outside of the system. For example, desorbed carbon containing material may be exported for injecting into geological formations, or converted to products like fuel or other chemicals. The regenerated molten salt may also be referred to as carbon lean molten salt or lean molten salt herein. The lean molten salt may be transferred back to the absorber for another cycle of carbon capture.

Upon contacting the flue gas, containing the carbon containing material, with a stream comprising molten salt (e.g., the first stream), an exothermic reaction may occur as the carbon containing material is reacts and is absorbed into the borate salt. The heat generated from the exothermic reaction may be captured in-situ and may be used to heat process fluid within tubes integrated throughout the packing material in a packed bed of the convection section, thereby recovering energy. In some embodiments, the process fluid is water to generate steam. In some embodiments, the process fluid is steam to generate superheated steam. In some embodiments, the process fluid is air to generate hot air or pre-heater air. In some embodiments, a process fluid may comprise a combination of water, steam, and air. The flow of heat transfer medium (e.g., steam) through the tubes may control the temperature of the absorber. In some embodiments, the packing material of the absorber is integrated with the exchanger (e.g., salt-salt heat exchanger). In such embodiments, the heat exchanger may comprise steam bundles for the generation of steam. A steam bundle may comprise one or more pipes located inside a boiler which comprise water. A steam bundle may be referred to herein as a water tube or a wing wall.

Absorption of carbon containing material alter the structure of the initial borate salt. For example, carbon dioxide may react with a borate salt to form a carbonate and an altered borate salt as shown below:

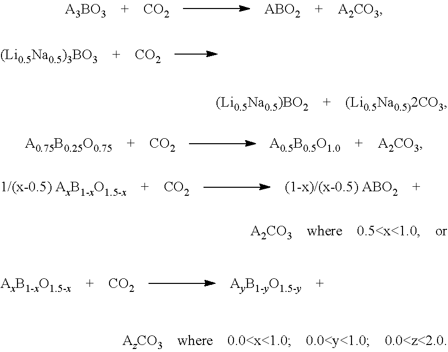

The reaction between a borate salt and carbon dioxide may be reversible. In some embodiments, the resulting carbonate (A₂CO₃) is a liquid. In some embodiments, other components of the flue gas (e.g., components which were not absorbed by the borate salt) may exit the system through an exhaust stack.

An exothermic reaction may occur as the carbon containing material is reacts and is absorbed into the borate salt. The desorption of CO₂ from carbon containing material may be an endothermic reaction. For instance, the desorption of CO₂ from the molten salt stream (235) in the desorber (240) may be an endothermic reaction. Heat (e.g., from steam) may facilitate the endothermic reaction of CO₂ desorption from a molten salt stream.

The method and systems described herein may comprise a small amount of steam in the process of desorbing carbon containing material from a stream comprising molten salt. In some embodiments, steam may occupy a head space in proximity to carbon rich stream during desorption. In some embodiments, for at least a portion of the time during which desorption is performed, a head space may contain steam in an amount of at most 70 weight percent (wt %), 60 wt %, 50 wt %, 40 wt %, 30 wt %, 20 wt %, 10 wt %, 5 wt %, 1 wt %, or less. In some embodiments, for at least a portion of the time during which desorption is performed, a head space may contain about 0 wt % steam. In some embodiments, for at least a portion of the time during which desorption is performed, a head space may contain no detectable amount of steam. The remaining volume in the head space may comprise carbon containing gas.

In some embodiments, the molar ratio of steam in the gas phase to carbon containing material absorbed in the carbon rich stream (e.g., second stream) in the desorber during desorption may be, at least for a portion of the time during which desorption occurs, at most 1, at most 0.9, 0.8, 0.7, 0.6, 0.5, 0.4, 0.3, 0.2, 0.1, 0.05, or less. In some embodiments, the molar ratio of steam in the gas phase to carbon containing material absorbed in the carbon rich stream may be 0.

In some embodiments, the molar ratio of steam in the gas to molten salt in the desorber may be at most 0.1, 0.05, 0.01, or less. In some embodiments, the molar ratio of steam in the gas to molten salt in the desorber may be 0.

In some embodiments, the second stream transported to the desorber may contain steam in an amount of at most 70 mol %, 60 mol %, 50 mol %, 40 mol % steam, 30 mol % steam, 20 mol % steam, 10 mol % steam, 5 mol % steam, 2 mol % steam, 1 mol % steam, 0.5 mol % steam, or less. In some embodiments, the second stream may comprise about 0 mol % steam. In some embodiments, the second stream may comprise no steam. In some embodiments, the second stream may have no detectable steam.

In some embodiments, the stream comprising regenerated molten salt (third stream) may comprise less than 50 mole percent (mol %) steam, 40 mol % steam, 30 mol % steam, 20 mol % steam, 10 mol % steam, 5 mol % steam, 2 mol % steam, 1 mol % steam, 0.5 mol % steam, or less. In some embodiments, the third stream may comprise less than 20 mol % steam. In some embodiments, the third stream may comprise less than 10 mol % steam. In some embodiments, the third stream may comprise less than 5 mol % steam. The method and systems described herein may not use steam in the process of desorbing carbon containing material from a molten salt stream during the regeneration process. In some embodiments, the third stream may comprise about 0 mol % steam. In some embodiments, the third stream may comprise no steam. In some embodiments, the third stream may have no detectable steam.

Desorbed carbon containing material may be prepared for export from the desorber. In some cases, desorbed carbon containing material may be stored on site. In some embodiments, the desorbed carbon containing material may be provided as an export stream. In some embodiments, the export stream may comprise a concentration of carbon containing material (e.g., carbon dioxide) at a concentration of at least about 50%, 60%, 70%, 80%, 90%, 95%, 99%, 99.9%, or more. In some embodiments, the export stream may comprise a concentration of carbon containing material at a concentration of at least about 80%. In some embodiments, the export stream may comprise a concentration of carbon containing material at a concentration of at least about 90%. In some embodiments, the export stream may comprise a concentration of carbon containing material at a concentration of at least about 95%. In some embodiments, the export stream may comprise a concentration of carbon containing material at a concentration of at least about 99%. In some embodiments, the export stream may comprise a concentration of carbon containing material at a concentration of at least about 99.9%.

In some embodiments, the export stream may pass through the convection section of the high temperature system. Passing the export stream through the convection section may cool the stream and recover heat through generation of steam, or transfer of heat to another process fluid.

### Computer Systems

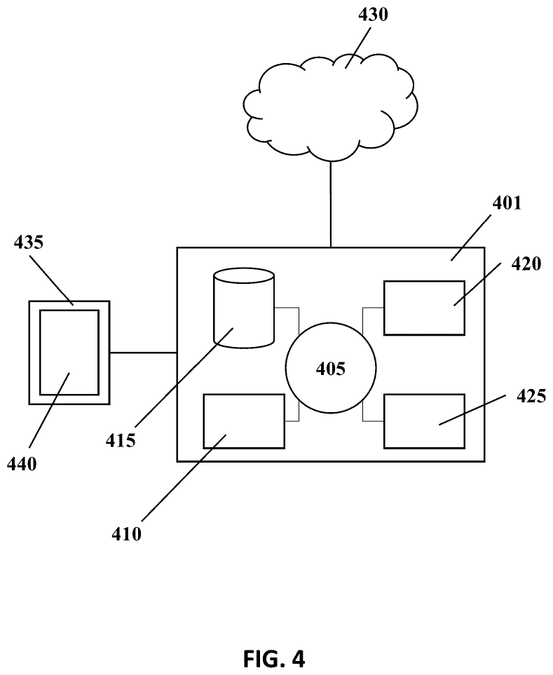

In an aspect, the present disclosure provides computer systems that are programmed or otherwise configured to implement methods of the disclosure, e.g., any of the subject methods for capturing carbon dioxide using molten salts. FIG. 4 shows a computer system 401 that is programmed or otherwise configured to implement a method for capturing carbon dioxides using molten salts. The computer system 401 may be configured to, for example, control the flow of carbon dioxide into the system or to monitor energy output as discussed elsewhere herein. The computer system 401 can be an electronic device of a user or a computer system that is remotely located with respect to the electronic device. The electronic device can be a mobile electronic device.

The computer system 401 may include a central processing unit (CPU, also “processor” and “computer processor” herein) 405, which can be a single core or multi core processor, or a plurality of processors for parallel processing. The computer system 401 also includes memory or memory location 410 (e.g., random-access memory, read-only memory, flash memory), electronic storage unit 415 (e.g., hard disk), communication interface 420 (e.g., network adapter) for communicating with one or more other systems, and peripheral devices 425, such as cache, other memory, data storage and/or electronic display adapters. The memory 410, storage unit 415, interface 420 and peripheral devices 425 are in communication with the CPU 405 through a communication bus (solid lines), such as a moth-erboard. The storage unit 415 can be a data storage unit (or data repository) for storing data. The computer system 401 can be operatively coupled to a computer network (“network”) 430 with the aid of the communication interface 420. The network 430 can be the Internet, an internet and/or extranet, or an intranet and/or extranet that is in communication with the Internet. The network 430 in some cases is a telecommunication and/or data network. The network 430 can include one or more computer servers, which can enable distributed computing, such as cloud computing. The network 430, in some cases with the aid of the computer system 401, can implement a peer-to-peer network, which may enable devices coupled to the computer system 401 to behave as a client or a server.

The CPU 405 can execute a sequence of machine-readable instructions, which can be embodied in a program or software. The instructions may be stored in a memory location, such as the memory 410. The instructions can be directed to the CPU 405, which can subsequently program or otherwise configure the CPU 405 to implement methods of the present disclosure. Examples of operations performed by the CPU 405 can include fetch, decode, execute, and writeback.

The CPU 405 can be part of a circuit, such as an integrated circuit. One or more other components of the system 401 can be included in the circuit. In some cases, the circuit is an application specific integrated circuit (ASIC).

The storage unit 415 can store files, such as drivers, libraries and saved programs. The storage unit 415 can store user data, e.g., user preferences and user programs. The computer system 401 in some cases can include one or more additional data storage units that are located external to the computer system 401 (e.g., on a remote server that is in communication with the computer system 401 through an intranet or the Internet).

The computer system 401 can communicate with one or more remote computer systems through the network 430. For instance, the computer system 401 can communicate with a remote computer system of a user (e.g., an operator overseeing or monitoring the capturing of carbon dioxide or energy output, etc.). Examples of remote computer systems include personal computers (e.g., portable PC), slate or tablet PC's (e.g., Apple® iPad, Samsung Galaxy Tab), telephones, Smart phones (e.g., Apple® iPhone, Android-enabled device, Blackberry®), or personal digital assistants. The user can access the computer system 401 via the network 430.

Methods as described herein can be implemented by way of machine (e.g., computer processor) executable code stored on an electronic storage location of the computer system 401, such as, for example, on the memory 410 or electronic storage unit 415. The machine executable or machine readable code can be provided in the form of software. During use, the code can be executed by the processor 405. In some cases, the code can be retrieved from the storage unit 415 and stored on the memory 410 for ready access by the processor 405. In some situations, the electronic storage unit 415 can be precluded, and machine-executable instructions are stored on memory 410.

The code can be pre-compiled and configured for use with a machine having a processor adapted to execute the code, or can be compiled during runtime. The code can be supplied in a programming language that can be selected to enable the code to execute in a pre-compiled or as-compiled fashion.

Aspects of the systems and methods provided herein, such as the computer system 401, can be embodied in programming. Various aspects of the technology may be thought of as “products” or “articles of manufacture” typically in the form of machine (or processor) executable code and/or associated data that is carried on or embodied in a type of machine readable medium. Machine-executable code can be stored on an electronic storage unit, such as memory (e.g., read-only memory, random-access memory, flash memory) or a hard disk. “Storage” type media can include any or all of the tangible memory of the computers, processors or the like, or associated modules thereof, such as various semiconductor memories, tape drives, disk drives and the like, which may provide non-transitory storage at any time for the software programming. All or portions of the software may at times be communicated through the Internet or various other telecommunication networks. Such communications, for example, may enable loading of the software from one computer or processor into another, for example, from a management server or host computer into the computer platform of an application server. Thus, another type of media that may bear the software elements includes optical, electrical and electromagnetic waves, such as used across physical interfaces between local devices, through wired and optical landline networks and over various air-links. The physical elements that carry such waves, such as wired or wireless links, optical links or the like, also may be considered as media bearing the software. As used herein, unless restricted to non-transitory, tangible “storage” media, terms such as computer or machine “readable medium” refer to any medium that participates in providing instructions to a processor for execution.

Hence, a machine readable medium, such as computer-executable code, may take many forms, including but not limited to, a tangible storage medium, a carrier wave medium or physical transmission medium. Non-volatile storage media including, for example, optical or magnetic disks, or any storage devices in any computer(s) or the like, may be used to implement the databases, etc. shown in the drawings. Volatile storage media include dynamic memory, such as main memory of such a computer platform. Tangible transmission media include coaxial cables; copper wire and fiber optics, including the wires that comprise a bus within a computer system. Carrier-wave transmission media may take the form of electric or electromagnetic signals, or acoustic or light waves such as those generated during radio frequency (RF) and infrared (IR) data communications. Common forms of computer-readable media therefore include for example: a floppy disk, a flexible disk, hard disk, magnetic tape, any other magnetic medium, a CD-ROM, DVD or DVD-ROM, any other optical medium, punch cards paper tape, any other physical storage medium with patterns of holes, a RAM, a ROM, a PROM and EPROM, a FLASH-EPROM, any other memory chip or cartridge, a carrier wave transporting data or instructions, cables or links transporting such a carrier wave, or any other medium from which a computer may read programming code and/or data. Many of these forms of computer readable media may be involved in carrying one or more sequences of one or more instructions to a processor for execution.

The computer system 401 can include or be in communication with an electronic display 435 that comprises a user interface (UI) 440 for providing, for example, a portal for a user to monitor or track one or more processes for fabricating flexible film materials from waste cooking oil and compounds derived therefrom. The portal may be provided through an application programming interface (API). A user or entity can also interact with various elements in the portal via the UI. Examples of UI's include, without limitation, a graphical user interface (GUI) and web-based user interface.

Methods and systems of the present disclosure can be implemented by way of one or more algorithms. An algorithm can be implemented by way of software upon execution by the central processing unit 405. For example, the algorithm may be configured to adjust an operation of the system depending on energy needs (e.g., decrease in energy output or increase in energy output).

### EXAMPLES

Example 1: CO₂ capture and thermochemical energy storage, where CO₂ supply to storage tanks can be externally supplied. An input flow of CO₂ rich gas 205 may be directed to an embodiment of the integrated carbon capture and thermochemical storage system (FIG. 2). This input flow of CO₂ rich gas 205 may be referred to as a first stream comprising CO₂ herein. The first stream comprising CO₂ 205 may be directed to an absorber 210 which contains molten salts that may absorb CO₂ through an exothermic chemical reaction. At least a portion of CO₂ from the first stream comprising CO₂ 205 may be absorbed into the molten salt upon contact, which may release energy into the absorber 210, and may provide a molten salt stream comprising absorbed CO₂ 220. Absorption of CO₂ from the first stream comprising CO₂ 205 may yield a CO₂ lean stream 215 that is directed out of the absorber 210 and out of the integrated carbon capture and thermochemical storage system.

The molten salt stream comprising absorbed CO₂ 220 can be directed into a storage tank 280. The storage tank may comprise molten salt 225 and a headspace 230. A second stream comprising CO₂ 270 may be directed into the headspace of the storage tank 230. The second stream comprising CO₂ 270 may be from various sources, such as an external CO₂ tank or flue gas from a different industrial process. At least a portion of CO₂ from the second stream comprising CO₂ 270 may be absorbed into the molten salt in the storage tank 225 through an exothermic chemical reaction. At least a portion of CO₂ from the second stream comprising CO₂ 270 may be absorbed into the molten salt 225 upon contact, which may release energy into the storage tank 280 and increase the CO₂ concentration of the molten salt stream 235. In some embodiments, the molten salt stream entering the storage tank 220 and the molten salt stream exiting the storage tank 235 may have about the same CO₂ concentration. In some embodiments, the molten salt stream entering the storage tank 220 and the molten salt stream exiting the storage tank 235 may have different CO₂ concentrations. The heat released by CO₂ absorption in the storage tank 280 may maintain the temperature of the molten salt 225 above its freezing point. Taken together, the second stream comprising CO₂ 270 may be used to manipulate the temperature of the storage tank 280.

The molten salt stream exiting the storage tank 235 may be directed to a desorber 240 where CO₂ is desorbed, yielding a third stream comprising CO₂ 245 and an additional molten salt stream 250. In some embodiments, the molten salt stream entering the desorber 235 and the additional molten salt stream 250 may have different CO₂ concentrations. In some embodiments, the molten salt stream entering the desorber 235 has a higher CO₂ concentration than the additional molten salt stream 250.

The additional molten salt stream exiting the desorber 250 may be directed to an additional storage tank 285. The additional storage tank may comprise molten salt 255 and a headspace 260. A fourth stream comprising CO₂ 275 may be directed into the headspace of the additional storage tank 260. The fourth stream comprising CO₂ 275 may be from various sources, such as an external CO₂ tank or flue gas from a different industrial process. At least a portion of CO₂ from the fourth stream comprising CO₂ 275 may be absorbed into the molten salt in the additional storage tank 255 through an exothermic chemical reaction. At least a portion of CO₂ from the fourth stream comprising CO₂ 275 may be absorbed into the molten salt 255 upon contact, which may release energy into the additional storage tank 285 and may increase the CO₂ concentration of the additional molten salt stream 265. In some embodiments, the additional molten salt stream entering the additional storage tank 250 and the additional molten salt stream exiting the additional storage tank 265 may have about the same CO₂ concentration. In some embodiments, the additional molten salt stream entering the additional storage tank 250 and the additional molten salt stream exiting the additional storage tank 265 may have different CO₂ concentrations. The heat released by CO₂ absorption in the additional storage tank 285 may maintain the temperature of the molten salt 255 above its freezing point. Taken together, the fourth stream comprising CO₂ 275 may be used to manipulate the temperature of the additional storage tank 285.

The additional molten salt stream exiting the additional storage tank 265 may be directed back to the absorber 210. The additional molten salt stream 265 may contact the first stream comprising CO₂ 205 in the absorber 210, which may enable further absorption of CO₂ from the first stream comprising CO₂ 205.

### Example 2: CO₂ Capture and Thermochemical Energy Storage, where CO₂ Supply to Storage Tanks can be from Flue Gas or Recycled Gas Streams

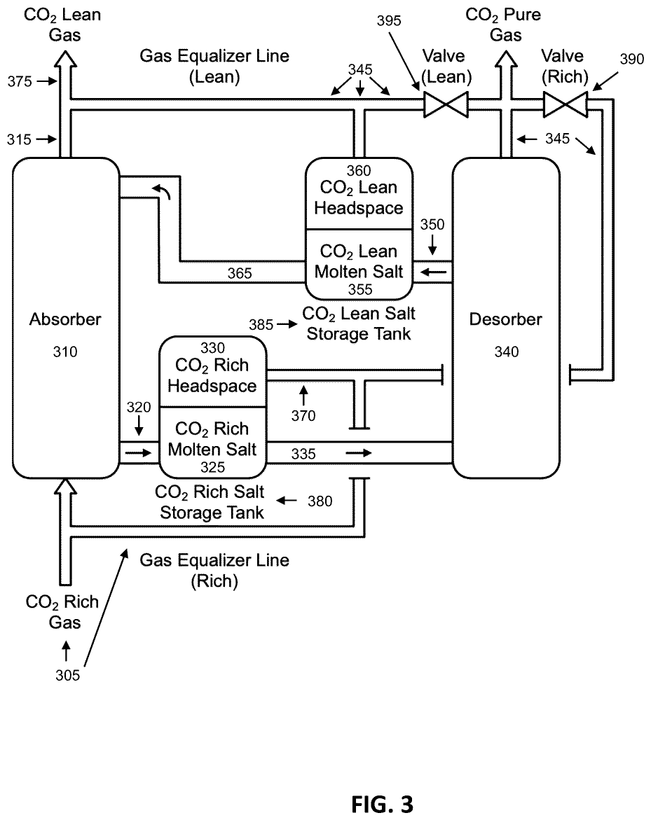

An input flow of CO₂ rich gas 305 may be directed to an embodiment of the integrated carbon capture and thermochemical storage system (FIG. 3). This input flow of CO₂ rich gas 305 may be referred to as a first stream comprising CO₂ herein. The first stream comprising CO₂ 305 may be directed to an absorber 310 which contains molten salts that may absorb CO₂ through an exothermic chemical reaction. At least a portion of CO₂ from the first stream comprising CO₂ 305 may be absorbed into the molten salt upon contact, which may release energy into the absorber 310, and may provide a molten salt stream comprising absorbed CO₂ 320. Absorption of CO₂ from the first stream comprising CO₂ 305 may yield a CO₂ lean stream 315 that is directed out of the absorber 310.

The molten salt stream comprising absorbed CO₂ 320 can be directed into a storage tank 380. The storage tank may comprise molten salt 325 and a headspace 330. A second stream comprising CO₂ 370 may be directed into the headspace of the storage tank 330.

The second stream comprising CO₂ 370 may comprise the first stream comprising CO₂ 305. The second stream comprising CO₂ 370 may comprise the third stream comprising CO₂ 345. The second stream comprising CO₂ 370 may comprise the first stream comprising CO₂ 305 and the third stream comprising CO₂ 345. The first stream comprising CO₂ 305, the second stream comprising CO₂ 370, and the third stream comprising CO₂ 345 may have about the same or different CO₂ concentrations. At least a portion of CO₂ from the second stream comprising CO₂ 370 may be absorbed into the molten salt in the storage tank 325 through an exothermic chemical reaction. At least a portion of CO₂ from the second stream comprising CO₂ 370 may be absorbed into the molten salt 325 upon contact, which may release energy into the storage tank 380 and increase the CO₂ concentration of the molten salt stream 335. In some embodiments, the molten salt stream entering the storage tank 320 and the molten salt stream exiting the storage tank 335 may have about the same CO₂ concentration. In some embodiments, the molten salt stream entering the storage tank 320 and the molten salt stream exiting the storage tank 335 may have different CO₂ concentrations. The heat released by CO₂ absorption in the storage tank 380 may maintain the temperature of the molten salt 325 above its freezing point. Taken together, the second stream comprising CO₂ 370, which comprises CO₂ derived from carbon emissions by industrial processes, may be used to manipulate the temperature of the storage tank 380.

The molten salt stream exiting the storage tank 335 may be directed to a desorber 340 where CO₂ is desorbed, yielding a third stream comprising CO₂ 345 and an additional molten salt stream 350. In some embodiments, the molten salt stream entering the desorber 335 and the additional molten salt stream 350 may have different CO₂ concentrations. In some embodiments, the molten salt stream entering the desorber 335 has a higher CO₂ concentration than the additional molten salt stream 350. The third stream comprising CO₂ 345 may be directed out of the desorber 340 and out of the integrated carbon capture and thermochemical storage system. In some embodiments, the flow of the third stream comprising CO₂ 345 may be controlled by a first valve 390, which directs the flow of the third stream comprising CO₂ 345 towards the storage tank 380, and a second valve 395, which yields a stream comprising CO₂ 346 towards the additional storage tank 385. Valve 395 may have a control mechanism to control the flow rate of CO₂ exiting the valve. The flow rate of CO₂ can be adjusted or modulated to achieve a desired composition of CO₂ in stream 346 or headspace 360.

In some embodiments, the CO₂ lean stream 315 that is directed out of the absorber 310 may merge with the third stream comprising CO₂ 346, yielding a gaseous exit stream 375 that is directed out of the integrated carbon capture and thermochemical storage system. The CO₂ lean stream 315 and the gaseous exit stream 375 may have about the same or different CO₂ concentrations.

The additional molten salt stream exiting the desorber 350 may be directed to an additional storage tank 385. The additional storage tank may comprise molten salt 355 and a headspace 360. A fourth stream comprising CO₂ 346 may be directed into the headspace of the additional storage tank 360. At least a portion of CO₂ from the fourth stream comprising CO₂ 346 may be absorbed into the molten salt in the additional storage tank 355 through an exothermic chemical reaction. At least a portion of CO₂ from the fourth stream comprising CO₂ 346 may be absorbed into the molten salt 355 upon contact, which may release energy into the additional storage tank 385 and may increase the CO₂ concentration of the additional molten salt stream 365. In some embodiments, the additional molten salt stream entering the additional storage tank 350 and the additional molten salt stream exiting the additional storage tank 365 may have about the same CO₂ concentration. In some embodiments, the additional molten salt stream entering the additional storage tank 350 and the additional molten salt stream exiting the additional storage tank 365 may have different CO₂ concentrations. The heat released by CO₂ absorption in the additional storage tank 385 may maintain the temperature of the molten salt 355 above its freezing point. Taken together, the fourth stream comprising CO₂ 346 may be used to manipulate the temperature of the additional storage tank 385.

The additional molten salt stream exiting the additional storage tank 365 may be directed back to the absorber 310. The additional molten salt stream 365 may contact the first stream comprising CO₂ 305 in the absorber 310, which may enable further absorption of CO₂ from the first stream comprising CO₂ 305.

### Example 3: Asymmetric Molten Salt Flows, where Level of Molten Salt in the Storage Tank is Decreasing

The thermal output of the CO₂ producing system can be ramped up or down by regulating the flow of molten salt from the absorber [220, 320] into the storage tank [280, 380] and the flow of molten salt from the storage tank [235, 335] into the desorber [240, 340]. When the molten salt level in the storage tank [225, 325] is decreasing (i.e., when the flow of molten salt to the desorber [235, 335] is greater than the flow of molten salt to the storage tank [220, 320]), the total pressure in the headspace [230, 330] may decrease and the endothermic desorption reaction may proceed, thereby reducing the temperature of the storage tank [280, 380] and putting the system at risk of freezing. To counteract this, a CO₂ comprising gas stream from the discharge of the desorber [345, 370] may be routed back to the storage tank in order to maintain the partial pressure of the system by increasing the concentration of CO₂ in the headspace as the total pressure decreases.

### Example 4: Asymmetric Molten Salt Flows, where Level of Molten Salt in the Storage Tank is Increasing

The thermal output of the CO₂ producing system can be ramped up or down by regulating the flow of molten salt from the absorber [220, 320] into the storage tank [280, 380] and the flow of molten salt from the storage tank [235, 335] into the desorber [240, 340]. When the molten salt level in the storage tank [225, 325] is increasing (i.e., when the flow of molten salt to the storage tank [220, 320] is greater than the flow of molten salt to the desorber [235, 335]), the total pressure in the headspace [230, 330] may increase and the exothermic absorption reaction may proceed, thereby increasing the temperature of the storage tank [280, 380]. This heat may be maintained in the storage tank [280, 380] to offset losses due to imperfect insulation.

In some instances, inert gas may be added to the storage tank [280, 380] when necessary, outside of normal operation, to maintain the required composition of gas in the headspace [230, 330]. This can result in a decrease in CO₂ concentration in the headspace [230, 330] and a cooling of the storage tank [280, 380]. As such, the addition of inert gas to the storage tank [280, 380], may optimally be executed when the power output of the CO₂ producing system is stable and the temperature of the storage tank [280, 380] can be maintained above the freezing point of the molten salt.

1. A method comprising:
(a) directing a stream comprising carbon dioxide (CO₂) into an absorber comprising a molten salt;
(b) in said absorber, contacting said stream comprising CO₂ with said molten salt such that at least a portion of CO₂ from said stream is absorbed into said molten salt to provide a molten salt stream, wherein said molten salt stream comprises absorbed CO₂;
(c) directing said molten salt stream from said absorber to a storage tank; and
(d) controlling a flow of at least a portion of said molten salt stream from said storage tank to a desorber based at least in part on a demand for an energy.

2. (canceled)

3. The method of claim 1, wherein said stream comprising CO₂ is a first stream comprising CO₂, and wherein said method further comprises directing a second stream comprising CO₂ to said storage tank such that at least a portion of CO₂ in said second stream is absorbed into said molten salt stream in said storage tank, thereby resulting in an increased amount of CO₂ in said molten salt stream.

4. The method of claim 1, wherein (d) comprises initiating or increasing said flow of said at least portion of said molten salt stream from said storage tank to said desorber when said demand is below a threshold value.

5. The method of claim 3, wherein said absorption of CO₂ from said second stream into said molten salt stream releases heat into said storage tank.

6. The method of claim 5, wherein said heat maintains said molten salt stream in said storage tank at a temperature or temperature range above a freezing point of said molten salt stream.

7. The method of claim 4, wherein in said desorber, CO₂ desorbs from said at least portion of said molten salt stream, resulting in a stream comprising desorbed CO₂ and an additional molten salt stream, wherein a concentration of CO₂ in said molten salt stream is greater than a concentration of CO₂ in said additional molten salt stream.

8. (canceled)

9. (canceled)

10. The method of claim 7, further comprising directing said additional molten salt stream to an additional storage tank.

11.-14. (canceled)

15. The method of claim 10, further comprising directing at least a portion of said additional molten salt stream to said absorber when said demand is above a threshold value.

16. The method of claim 15, wherein in said absorber, said at least said portion of said additional molten salt stream contacts said additional CO₂.

17. The method of claim 7, wherein at least a portion of said third stream comprising desorbed CO₂ is directed to a headspace of said storage tank.

18.-23. (canceled)

24. The method of claim 1, wherein a level of said molten salt stream in said storage tank is controlled in an absence of pressurizing or in an absence of depressurizing said storage tank.

25. (canceled)

26. (canceled)

27. The method of claim 1, wherein said stream comprising CO₂ is output from an industrial process.

28.-36. (canceled)

37. The method of claim 1, wherein said molten salt has a formula of AₓB₁₋ₓO_{1.5-x}, wherein ‘A’ is an ion with a positive charge, ‘B’ is boron, ‘O’ is oxygen, and ‘x’ is a number greater than or equal to 0.5 and less than 1.0.

38. (canceled)

39. (canceled)

40. The method of claim 1, wherein a concentration of CO₂ in said storage tank is at least about 0.1 mol per kilogram of said molten salt.

41.-54. (canceled)

55. The method of claim 3, wherein said second stream comprising CO₂ is directed to a headspace of said storage tank.

56. The method of claim 3, wherein said first stream comprising CO₂ and said second stream comprising CO₂ have a same composition.

57. The method of claim 1, wherein a volume of said storage tank is about 5 times greater than a total volume of molten salt used to absorb CO₂.

58. The method of claim 1, wherein (d) comprises halting or decreasing said flow of said at least portion of said molten salt stream from said storage tank to said desorber when said demand is above a threshold value.

59. The method of claim 1, wherein said demand for said energy is from an industrial process or an electric grid.

60. The method of claim 60, wherein said first stream comprising CO₂ is an output of said industrial process.
